(19) United States
(12) Patent Application Publication
(10) Pub. No.: US 2025/0244691 A1
(43) Pub. Date: Jul. 31, 2025

(54) IMAGE FORMING DEVICE

(71) Applicant: SHARP KABUSHIKI KAISHA, Osaka (JP)

(72) Inventor: Masayuki OTSUKA, Osaka (JP)

(21) Appl. No.: 19/035,203

(22) Filed: Jan. 23, 2025

(30) Foreign Application Priority Data
Jan. 26, 2024 (JP) 2024-010192

(51) Int. Cl. G03G 15/06; G03G 15/00; G03G 21/02

(52) U.S. Cl. CPC G03G 15/065; G03G 15/5016; G03G 15/5062; G03G 15/556; G03G 21/02

(57) ABSTRACT

A controller executes, at a first interval, which is a predetermined interval, first processing of performing only the image quality adjusting processing in a first period, which is a period until the first cumulative print rate exceeds a predetermined first reference value and the first image quality adjusting processing is performed, and performs the image quality adjusting processing at a second interval shorter than the first interval and executes second processing of performing determining processing by using the remaining amount determining processor in a second period, which is a period after a time point at which the image quality adjusting processing is executed first time after the first cumulative print rate exceeds the first reference value.

### TECHNICAL FIELD

The disclosure relates to an image forming device using an electrophotographic system, such as a copying machine, a multifunction peripheral, a printer, or a facsimile device.

### BACKGROUND ART

An image forming device of the electrophotographic system generally forms a toner image on a photoconductive drum by using a developing device and directly transfers the toner image formed on the photoconductive drum to a printing sheet by using a transferring device or once intermediately transfers the toner image to an intermediate transfer medium and transfers the toner image intermediately transferred to the intermediate transfer medium to the printing sheet by using the transferring device. Thus, the toner image transferred to the printing sheet is heated and melted by a fixing device and fixed to the sheet.

Such an image forming device consumes toner with formation of a toner image and thus separately includes a toner container housing toner to be refilled to the developing device. However, when a remaining amount of toner in the toner container runs out, the toner cannot be refilled into the developing device, thus the toner amount in the developing device may decrease, and the density may decrease even if a toner image is formed. Therefore, there is a technique of changing the frequency of performing image stabilization control for making the density of the toner image appropriate in accordance with the remaining amount of toner in the toner container, more specifically, a technique of increasing the frequency of performing the image stabilization control when the remaining amount of toner in the toner container decreases.

For example, there is an image forming device that, upon calculating that the remaining amount of toner in the toner container has become a threshold or lower based on a dot count of a formed image, increases the frequency of image stabilization control (called “image quality adjusting processing” in the disclosure), thereby suppressing deterioration in image density and quality during a reduction period of the remaining amount of toner.

### SUMMARY

### Technical Problem

The image forming device described above performs the image stabilization control at the same timing constantly and thus performs the image stabilization control at the same timing in both a case of forming a high-density toner image (e.g., a photograph or the like) with a large consumption amount of toner and a case of forming a low-density toner image (e.g., a text document or the like) with a small consumption amount of toner. Therefore, the image stabilization control cannot be performed at an appropriate timing in accordance with the consumption amount of toner. Determination as to whether the toner in the toner container has become empty (determination of a toner end) is performed by a toner density sensor that detects a toner amount (toner density) in a developing device separately provided, causing the cost to increase accordingly.

The disclosure has been made in view of the problems described above and aims to provide an image forming device that can reduce the frequency of interruption of image forming processing by performing image quality adjusting processing in a state where a remaining amount of toner in a toner container is low. The disclosure also aims to provide an image forming device that can perform, at an appropriate timing, determination of a toner end as to whether a toner container is empty even without providing a toner density sensor that detects a toner amount in a developing device.

### Solution to Problem

An image forming device according to the disclosure for achieving the object described above is an image forming device that forms an image on a sheet. The image forming device includes: a toner container housing a toner inside; a developing mechanism that forms a toner image on a surface of an image carrier using the toner supplied from the toner container; a developing power supply that supplies the developing mechanism with a developing bias, which is a predetermined voltage; an image sensor that detects an image density of the toner image; and a controller that can execute image forming processing of forming the toner image on the surface of the image carrier based on image data that is electronic data of the image formed on the sheet and image quality adjusting processing of forming an image quality adjusting toner image, which is a predetermined toner image, on the surface of the image carrier and adjusting a value of the developing bias based on image density information detected by the image sensor. The controller includes a first cumulative print rate calculator that calculates a first cumulative print rate obtained by adding and cumulating a sheet print rate, which is a ratio between an area of the toner image formed during the image forming processing and an area of the sheet, is calculated from the image data and the sheet print rate obtained each time the image forming processing is performed and a remaining amount determining processor that determines whether the toner remains in the toner container based on image density information of the image quality adjusting toner image detected by the image sensor when the image quality adjusting processing is performed, executes, at a first interval, which is a predetermined interval, first processing of performing only the image quality adjusting processing in a first period, which is a period until the first cumulative print rate exceeds a predetermined first reference value and the first image quality adjusting processing is performed, and performs the image quality adjusting processing at a second interval shorter than the first interval and executes second processing of performing determining processing by using the remaining amount determining processor in a second period, which is a period after a time point at which the image quality adjusting processing is executed first time after the first cumulative print rate exceeds the first reference value.

In the configuration described above, it is possible to perform, at an appropriate timing, determination of a toner end as to whether a toner container is empty even without providing a toner density sensor that detects a toner amount in a developing device. It is also possible to reduce the frequency of interruption of image forming processing by performing image quality adjusting processing in a state where a remaining amount of toner in a toner container is low.

In the image forming device according to the disclosure, the controller may further include a second cumulative print rate calculator that calculates a second cumulative print rate obtained by adding and cumulating the sheet print rate of the image newly formed in the image forming processing after the image quality adjusting processing is performed in the second period each time the image forming processing is performed, the first interval may be defined by the number of processed sheets, which is the number of sheets to be subjected to the image forming processing, and the second interval may be defined by a value of the second cumulative print rate.

In the image forming device according to the disclosure, the controller may further include a second cumulative print rate calculator that calculates a second cumulative print rate obtained by adding and cumulating the sheet print rate of the image newly formed in the image forming processing after the image quality adjusting processing is performed in the second period each time the image forming processing is performed and a continuation determiner that determines whether a state is a first state where next image data that is the image data to perform next image forming processing is present or a second state where the next image data is not present during the image forming processing in the second period and may determine whether to perform the second processing based on results of the second cumulative print rate calculator and the continuation determiner in the second period.

In the image forming device according to the disclosure, the controller may execute the second processing if a value of the second cumulative print rate has reached a second reference value, which is a value smaller than the first reference value, in a case where the continuation determiner determines that a state is the second state during the image forming processing in the second period and may perform the second processing if the value of the second cumulative print rate has reached a third reference value, which is larger than the second reference value and smaller than the first reference value, in a case where the continuation determiner determines that a state is the first state during the image forming processing.

In the image forming device according to the disclosure, the third reference value may be equal to or less than twice the second reference value.

In the image forming device according to the disclosure, the remaining amount determining processor may determine that the toner is not in the toner container in a case where the image density detected by the image sensor of the image quality adjusting toner image that is formed does not reach a target density even by changing the value of the developing bias and forming the image quality adjusting toner image during the image quality adjusting processing.

In the image forming device according to the disclosure, the image forming device may further include a display, and the controller may display, on the display, a message indicating that the toner container is empty in a case where the remaining amount determining processor determines that the toner does not remain in the toner container.

### BRIEF DESCRIPTION OF THE DRAWINGS

FIG. 1 is an explanatory diagram illustrating a schematic configuration of an image forming device according to an embodiment of the disclosure.

FIG. 2 is a view describing an image former of the image forming device illustrated in FIG. 1.

FIG. 3 is a view describing a toner container attached to the image forming device according to the present embodiment.

FIG. 4A is a cross-sectional view of a positional relationship between a photoconductive drum and an image sensor as viewed from the front side.

FIG. 4B is a side view viewed from the right side to illustrate the configuration of the image sensor.

FIG. 5 is a schematic configuration diagram representing devices and a part of controller included in the image forming device according to the present embodiment.

FIG. 6 is a view illustrating a relationship between a surface potential of a photoconductive drum and a developing bias.

FIG. 7 is a view describing an image quality adjusting toner image and a detection signal in the image sensor in the present embodiment.

FIG. 8 is a flowchart showing various operations performed by a controller according to the present embodiment.

FIG. 9 is a flowchart showing an operation of remaining amount determining processing performed by the controller according to the present embodiment.

FIG. 10 is an explanatory diagram illustrating a schematic configuration of another image forming device according to an embodiment of the disclosure.

### DETAILED DESCRIPTION OF THE INVENTION

Hereinafter, as an image forming device according to the disclosure, a monochrome multifunction peripheral that forms a monochrome image on a sheet P, which is a recording medium, will be described as an example.

### Image Forming Device

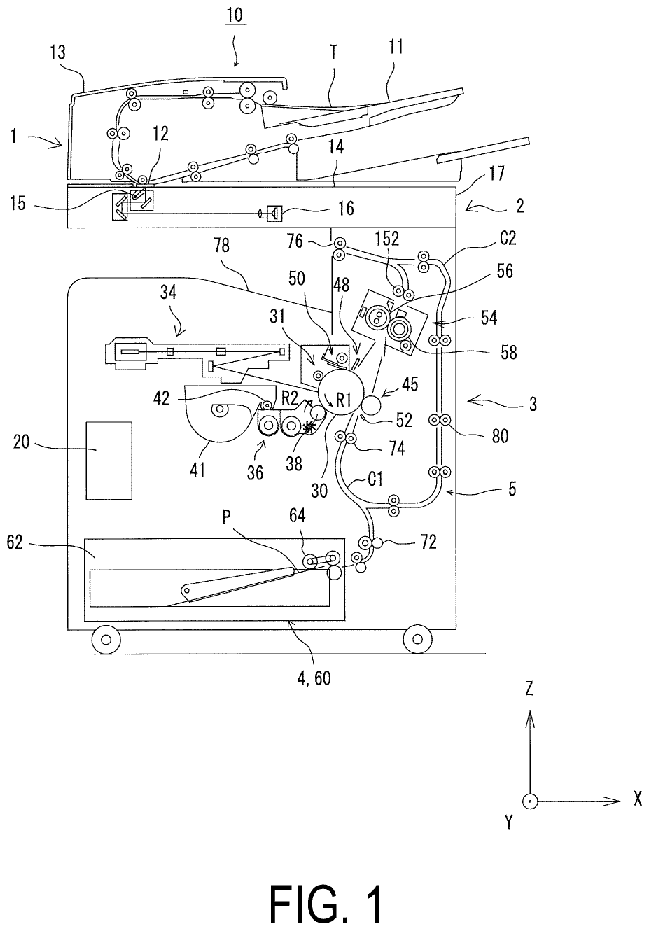

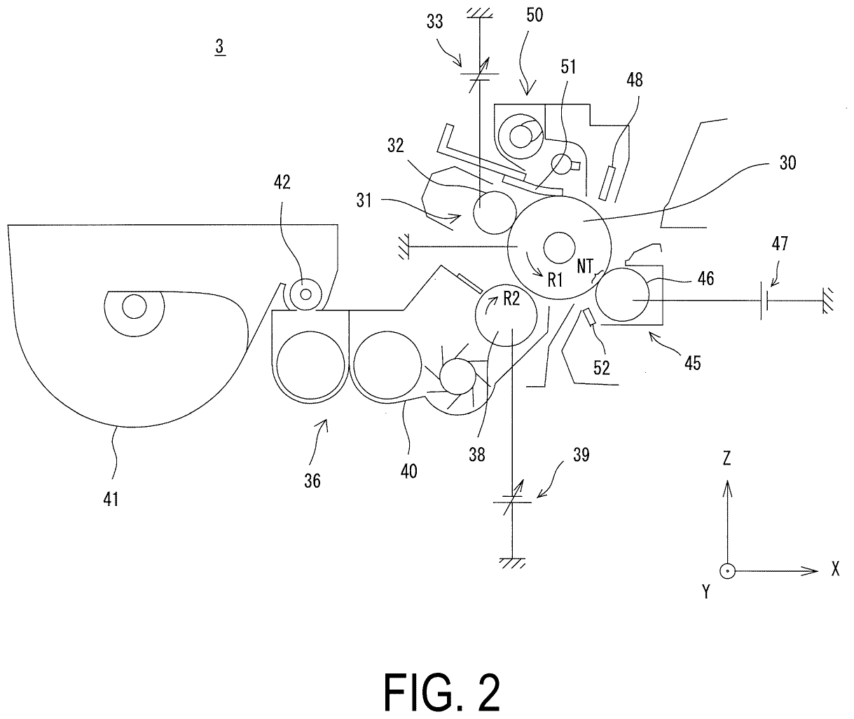

FIG. 1 is a cross-sectional view illustrating a schematic configuration of an image forming device 10 according to an embodiment of the disclosure. FIG. 2 is a schematic explanatory diagram extracting and describing a part of an image former 3 in FIG. 1.

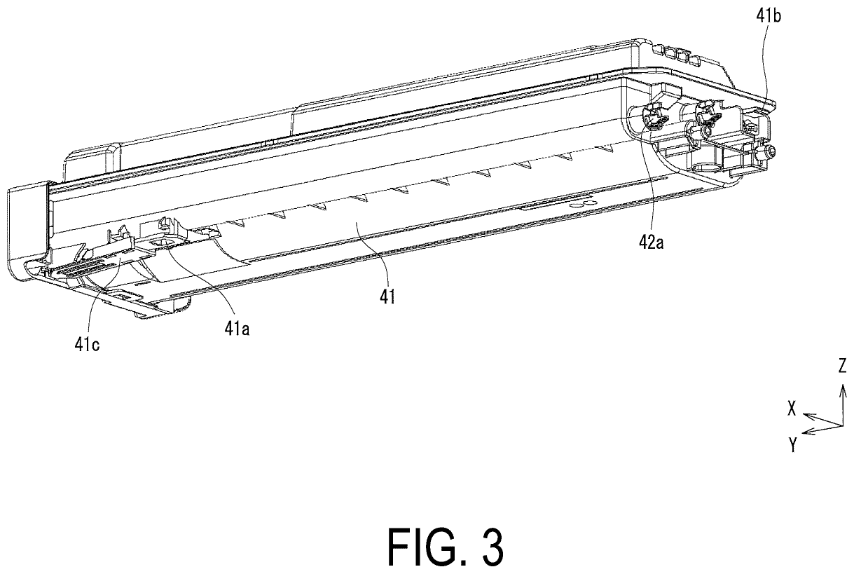

FIGS. 1 and 2 are each a view of the image forming device 10 as viewed from the front, in which an arrow X in the drawings indicates a width direction of the image forming device 10, and the direction indicated by the arrow is the right side and the opposite side is the left side. An arrow Y indicates a front-rear direction of the image forming device 10, and a direction indicated by the arrow (point) is a front side, and the opposite side is a back side. An arrow Z indicates an up-down direction, and a direction indicated by the arrow is an upper side and an opposite side is a lower side. FIG. 3 is a perspective view of a toner container 41 as viewed from the back side.

The image forming device 10 includes a document conveyor 1, a document reader 2, an image former 3, a paper feeder 4, and a sheet conveyor 5.

The document conveyor 1 is a document conveying device 13 that conveys, one by one to a document reading position 12, a document T placed on a document placing table 11 on which a plurality of documents can be placed.

The document reader 2 is a document reading device 17 including a document placing table 14 including a transparent member (e.g., glass or the like) on which the document T is placed, the document placing table 14 on which the document T is placed, a scanning optical unit 15 that is disposed below the document placing table 14 and can scanning in the left-right direction of the image forming device 10, and an imager 16 that images the document placed on the document placing table 14 via the scanning optical unit 15.

The imager 16 images, via the scanning optical unit 15, the document T sent to the document reading position 12 by the document conveying device 13, or the imager 16 images, by scanning the scanning optical unit 15, the document T placed on the document placing table 14, whereby the imager 16 reads and digitizes the document T.

The paper feeder 4 is a housing of the sheet P on which an image is formed, and the sheet conveyor 5 conveys, to the image former 3, the sheet P housed in the paper feeder 4.

The image former 3 forms an image on the sheet P based on image data read and digitized by the document reading device 17 or image data sent from a personal computer or the like. Here, the image former 3 includes a photoconductive drum 30, a charging device 31, an exposing device 34, a developing device 36, a transferring device 45, a static eliminating device 48, a cleaning device 50, the toner container 41, and a fixing device 54.

The photoconductive drum 30 includes a conductive cylindrical member that is grounded and a photosensitive layer formed outside the cylindrical member. The photosensitive layer includes a photoconductor having an insulating property in a dark place, the photoconductor in which a region irradiated with light changes to be conductive. The photoconductive drum 30 is rotated in a direction of an arrow RI in the drawing by a driving source (not illustrated) provided in the body of the image forming device 10.

The charging device 31 includes a charging roller 32 having a conductive shaft and a conductive elastic layer formed outside the shaft. The charging roller 32 is disposed such that the surface of the conductive elastic layer is in contact with the surface of the photoconductive drum 30, and is pivotally supported so as to rotate together with the rotation of the photoconductive drum 30. A charging power supply 33 that outputs a charging bias, which is a predetermined voltage or current, is connected to the conductive shaft and receives supply of the charging bias from the charging power supply 33 to charge the surface of the photoconductive drum 30 to a predetermined potential (e.g., about −600 V). Note that the charging power supply 33 is provided in the body of the image forming device 10.

The exposing device 34 includes a light emitter (e.g., a laser diode), and exposes the surface (photosensitive layer) of the photoconductive drum 30 based on the printing image data. In an exposure region, which is a region exposed by irradiation light from the light emitter, the resistance value decreases and the surface potential decreases, and an electrostatic latent image corresponding to the printing image data is formed.

The surface potential of the exposure region is closer to the ground potential than the non-exposure region, which is the other region not exposed, and is, for example, about −50 to −100 V. Note that the exposing device 34 of the disclosure is a scanning type exposing device that scans, in the longitudinal direction of the photoconductive drum 30, a light beam emitted from the light emitter.

The developing device 36 includes a developing tank 40 housing a developer containing toner and a developing roller 38 that supplies the toner to the photoconductive drum 30 with part of the developer carried on a surface thereof. The developing roller 38 rotates in a direction of an arrow R2 in the drawing by a driving source (not illustrated). A developing power supply 39 is connected to the developing roller 38.

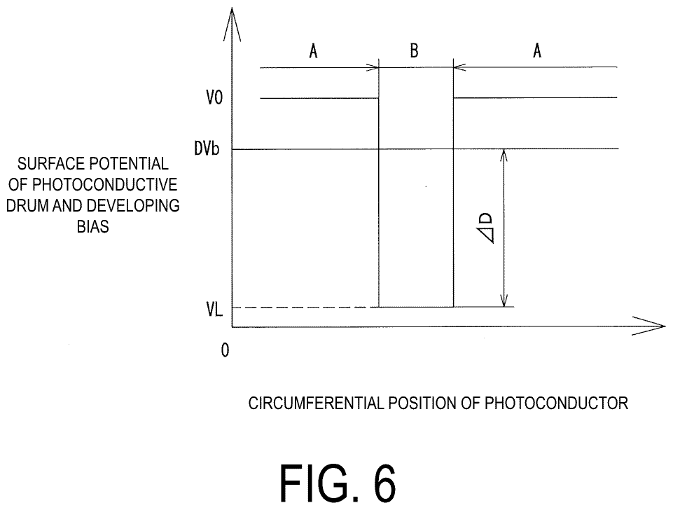

The developing roller 38 is supplied with a developing bias DVb of, for example, −400 V as a predetermined voltage from the developing power supply 39. The toner housed in the developing device 36 is charged with a predetermined negative charge, and when this developing bias DVb is supplied to the developing roller 38, a potential difference is generated between the developing bias DVb and the electrostatic latent image formed on the photoconductive drum 30, and the toner is developed in an exposed region (see FIG. 6).

By performing the above process, a toner image is formed on the photoconductive drum 30. Note that although described in detail later, the developing power supply 39 is configured to be able to change the value of the developing bias DVb supplied to the developing roller 38, and is provided in the body of the image forming device 10.

The developing device 36 is connected to the toner container 41 (toner cartridge) housing toner. FIG. 3 is a perspective view of the toner container 41 as viewed from the back side.

The toner container 41 is attachable to and detachable from the image forming device 10, and includes a discharge port 41a for discharging the toner housed inside the toner container 41 as illustrated in FIG. 3, a conveyor 42 that sequentially conveys the toner housed toward the discharge port 41a, and a terminal 41b provided with a storage mechanism (not illustrated) for storing the type and amount (a predetermined sheet print rate for a sheet of a predetermined size) of the toner housed therein and the corresponding image forming device 10.

When the toner container 41 is attached to the image forming device 10, the terminal 41b is connected to a connection terminal provided in the body of the image forming device 10, and a toner container detecting device 44 provided in the image forming device 10 can detect the attaching of the toner container 41 and the content stored in the storage of the terminal 41b.

When the toner container 41 is attached to the image forming device 10, the discharge port 41a is connected to the developing device 36, and when the conveyor 42 provided in the toner container 41 is rotated via a gear 42a by a toner refill device 43 having a toner refill motor (not illustrated), the toner housed therein is sent to the discharge port 41a and supplied to the developing device 36. Note that the toner container 41 is provided with a movable shutter 41c, and the discharge port 41a is configured to be covered by a biasing member (not illustrated) in a state where the toner container 41 is removed from the image forming device 10.

The transferring device 45 includes a transferring roller 46 having a conductive shaft and a conductive elastic layer formed outside the shaft. A transferring bias, which is a predetermined current, is shared by the conductive shaft of the transferring roller 46 from a transferring power supply 47. The transferring roller 46 comes into contact with the photoconductive drum 30, and rotates together with the photoconductive drum 30 when the photoconductive drum 30 is rotated by a driving source (not illustrated). The transferring roller 46 transfers, to the sheet P, the toner image formed on the photoconductive drum 30 when the sheet P sent from the paper feeder 4 is nipped and conveyed with the photoconductive drum 30 in a transferring nip region NT, which is a contact portion with the photoconductive drum 30. The transferring power supply 47 is also provided in the body of the image forming device 10.

The static eliminating device 48 includes a light source, and irradiates the surface of the photoconductive drum 30 before being cleaned by the cleaning device 50, thereby eliminating static charges so that the surface potential on the photoconductive drum 30 becomes a ground potential (e.g., a value close to 0 V) and erasing the electrostatic latent image formed on the photoconductive drum 30.

In the transferring device 45, a transferring residual toner, which is toner not being transferred to the sheet P but remaining on the photoconductive drum 30, is removed from the photoconductive drum 30 by the cleaning device 50, and is collected in a collection container provided in the image forming device 10 by a discharging device (not illustrated). The cleaning device 50 includes a cleaning blade 51 that comes into contact with the photoconductive drum 30 and scrapes off the transferring residual toner adhering to the surface of the photoconductive drum 30.

By undergoing static elimination by the static eliminating device 48 and cleaning by the cleaning device 50, next charging by the charging device 31 is prepared.

By repeating the above process, the image former 3 forms a toner image on the photoconductive drum 30 and forms (transfers) an image on the sheet P.

By a heating roller 56 incorporating a heating source and a pressure roller 58 sandwiching the sheet P to which the toner image has been transferred, the fixing device 54 fixes the toner image to the sheet P by pressure-feeding the toner image on the sheet P while heating it.

The paper feeder 4 includes a paper feeding device 60 including a sheet loader 62 that can load one or more sheets P and a paper feeding roller 64 that conveys, one by one, the sheets P loaded on the sheet loader 62.

The sheet conveyor 5 includes a first conveyance path C1 through which the sheet P sent one by one from the paper feeder 4 is conveyed to the transferring device 45 and the fixing device 54 in this order and the sheet P on which a toner image is fixed by the fixing device 54 is conveyed to a paper ejection tray 78, and a conveyance roller 72, a register roller 74, and a paper ejection roller 76 that are provided along the first conveyance path C1.

The register roller 74 temporarily stops the sheet P conveyed from the paper feeding device 60, and resumes the conveyance of the sheet P so as to be on time for the toner image formed on the photoconductive drum 30 to reach the transferring nip region NT.

The sheet conveyor 5 includes a second conveyance path C2 that sends the sheet P to the register roller 74 again in a case of forming an image on the opposite side surface on which no image is formed with respect to the sheet P on which an image is formed (what is called duplex printing). In the case of performing duplex printing, while the sheet P on which an image is formed is being conveyed by the paper ejection roller 76, the rotation direction is changed to the reverse direction, the sheet P being conveyed is switched back, and the sheet P is sent to the second conveyance path C2 for duplex printing. The sheet P conveyed to the second conveyance path C2 is conveyed toward the register roller 74 by a conveyance roller 80.

The above is the basic configuration of the image forming device 10 in the present embodiment.

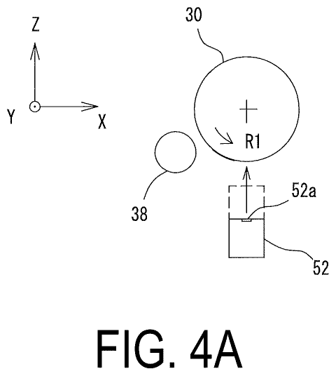

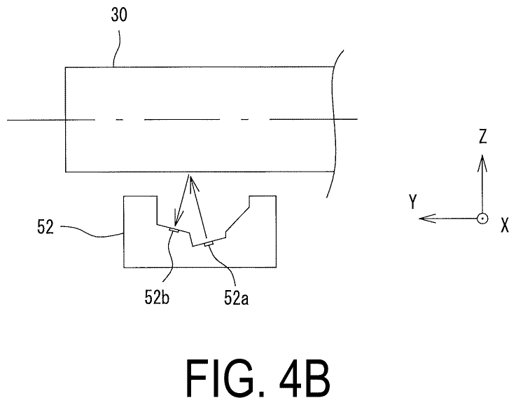

Note that a more upstream in the rotation direction of the photoconductive drum 30 than the transferring nip region NT includes an image sensor 52 that detects the image density of a toner image formed on the photoconductive drum 30. FIGS. 4A and 4B are views illustrating the image sensor 52, in which FIG. 4A is a front view of the image sensor 52 as viewed in the axial direction of the photoconductive drum 30, and FIG. 4B is a side view of the image sensor 52 as viewed from a direction intersecting the axial direction of the photoconductive drum 30.

The image sensor 52 includes a light emitter 52a and a light receiver 52b, and includes a reflective light sensor that emits light from the light emitter 52a toward the surface of the photoconductive drum 30 and receives, by the light receiver 52b, light reflected from the surface of the photoconductive drum 30.

### Schematic Configuration of Controller

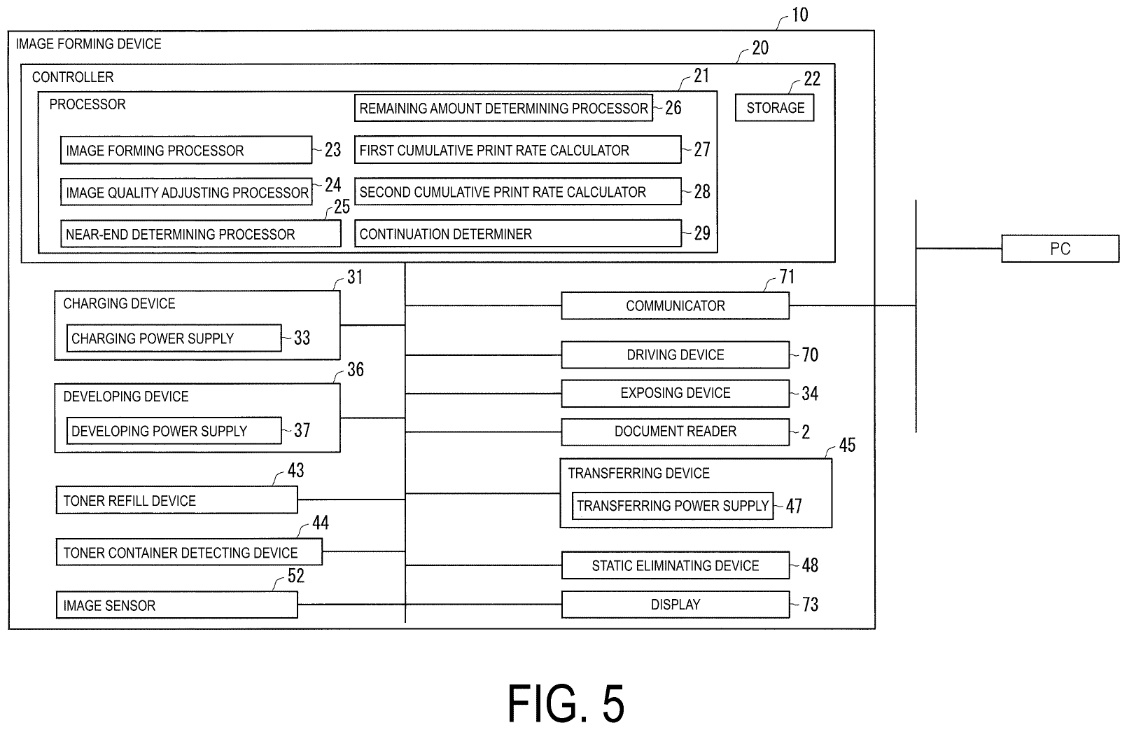

FIG. 5 is a schematic configuration diagram representing devices and a part of controller included in the image forming device according to the present embodiment.

The image forming device 10 according to the present embodiment includes the charging device 31, the exposing device 34, the developing device 36, the transferring device 45, the fixing device 54, the toner refill device 43, the toner container detecting device 44, and the image sensor 52 described above. The image forming device 10 further includes a driving device 70 including a driving source that rotates the photoconductive drum 30, the developing roller 38, and the like described earlier, a communicator 71 that receives, from an external terminal (a personal computer or a mobile terminal), image data to perform image forming processing, a display 73 that displays information necessary for operating the image forming device 10, and a controller 20 that controls the above-described device and the like. The controller 20 is connected to each of the above-described devices and sensors via a bus line or the like. Note that the display 73 may be a touch panel.

The controller 20 includes a processor 21 and a storage 22. The processor 21 is a microcomputer such as a CPU mounted with the image forming device 10, and the storage 22 includes a nonvolatile memory such as a ROM mounted on the image forming device 10 or a volatile memory such as a RAM.

The processor 21 controls the operation of the image forming device 10 by loading a control program stored in advance in the ROM of the storage 22 onto the RAM of the storage 22 and executing the program. The processor 21 includes an image forming processor 23 that performs processing of forming an image on the sheet P by controlling the operation of the image forming device 10, an image quality adjusting processor 24 that adjusts the image quality of an image to be formed on the sheet P, a near-end determining processor 25 that determines whether the remaining amount of toner used for image formation is close to empty, a remaining amount determining processor 26 that determines whether toner has run out, a first cumulative print rate calculator 27, a second cumulative print rate calculator 28, and a continuation determiner 29, all of which are controlling processors that perform predetermined processing by execution of a control program.

For example, the image forming processor 23 performs processing of forming an image (toner image) on the sheet P by controlling the charging device 31, the exposing device 34, the developing device 37, and the driving device 70 based on image data received from the document reader 2 or a personal computer PC or the like connected via the communicator 71, forming the toner image on the surface of the photoconductive drum 30, and controlling the transferring device 45 to transfer, to the sheet P, the toner image formed on the surface of the photoconductive drum 30. The image forming processor 23 performs processing of calculating a sheet print rate a (described later) from image data of the toner image formed on the surface of the photoconductive drum 30, and controlling the toner refill device 43 to supply the amount of toner corresponding to the sheet print rate a from the toner container 41 to the developing device 36.

The image quality adjusting processor 24, the near-end determining processor 25, the remaining amount determining processor 26, the first cumulative print rate calculator 27, the second cumulative print rate calculator 28, and the continuation determiner 29 will be described later.

### Image Quality Adjusting Processing

Before describing the image quality adjusting processor 24 and the image quality adjusting processing, the developing bias DVb in the developing device 36 and the potential of the electrostatic latent image formed on the surface of the photoconductive drum 30 will be described.

FIG. 6 is a view in which the horizontal axis represents the circumferential position of the photoconductive drum 30 and the vertical axis represents the surface potential of the photoconductive drum 30. The surface of the photoconductive drum 30 is charged to a predetermined potential VO (e.g., −600 V) by the charging device 31. Then, since the region of the photoconductive drum 30 exposed by the exposing device 34 becomes conductive, the potential decreases to a potential (e.g., −80 V) close to a ground potential called an exposure potential VL. Here, the region indicated by a symbol A in FIG. 6 is a non-exposure region A of the photoconductive drum 30, and a region indicated by a symbol B is an exposure region B.

The value of the developing bias DVb supplied to the developing roller 38 is set to a voltage value between the predetermined potential V0 such as −400 V and the exposure potential VL. By setting the value of the developing bias DVb in this manner, the non-exposure region A not supplied with the toner, and the exposure region B can be supplied with the toner. Note that the larger AD, which is a difference between the developing bias DVb and the exposure potential VL, is, the more toner is supplied to the exposure region B, and the higher the image density is. On the other hand, the toner charging amount may change due to a temporal change, an environmental change, or the like, and in such a case, even if the developing bias DVb having the same voltage is supplied to the developing roller 38, the toner amount to be developed may change, and the image density may change. Therefore, adjusting work of the developing bias DVb is necessary for making the same image density constantly.

This adjusting work of the developing bias DVb is the image quality adjusting processing.

Next, the image quality adjusting processing performed by the image quality adjusting processor 24 will be described.

The image quality adjusting processor 24 performs the image quality adjusting processing of adjusting the value of the developing bias DVb at predetermined intervals so that the density of the toner image is not too dark or too light.

At the time of the image quality adjusting processing, the image quality adjusting processor 24 controls the charging device 31, the exposing device 34, and the developing device 36, forms an image quality adjusting toner image TP, which is a predetermined toner image, on the surface of the photoconductive drum 30, and detects the image density thereof by the image sensor 52.

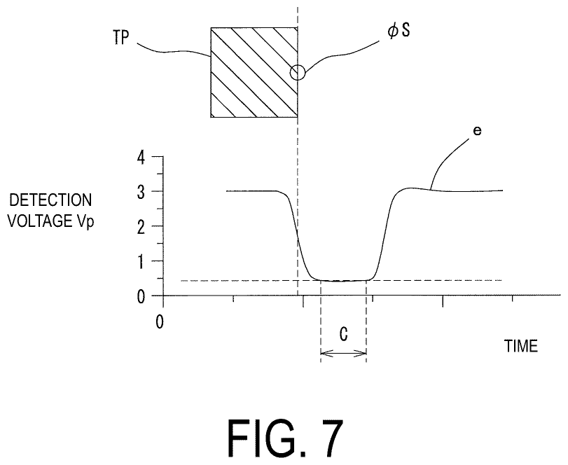

FIG. 7 is a view illustrating a shape of the image quality adjusting toner image TP in plan view, a detection region φS of the image sensor 52, and a detection signal of the light receiver 52b.

The detection region φS is a region where the light receiver 52b can measure the image density, and the diameter thereof is 1 mm.

The image quality adjusting toner image is what is called a patch image having a rectangular shape larger than the detection region φS, for example, 10 mm square, and the toner image is formed under the exposure condition that the toner is developed in the entire region of 10 mm square.

A curve indicated by a symbol e in the drawing indicates the detection signal of the light receiver 52b, and the vertical axis indicates a detection voltage Vp (unit V).

The light receiver 52b of the image sensor 52 has a characteristic that the magnitude of the detection signal changes according to the amount of light detected.

The light emission amount of the light emitter 52a of the image sensor 52 is adjusted such that the detection voltage Vp of the light receiver 52b becomes 3 V in a state where nothing is on the surface of the photoconductive drum 30.

Since the light emitted from the light emitter 52a is diffused or absorbed on the surface of the toner image, as the density of the toner image is higher (the toner amount is larger), the amount of light reaching the light receiver 52b decreases, and the detection voltage Vp also approaches 0 V.

Here, the region indicated by C in FIG. 7 indicates image density information of the image quality adjusting toner image, and the density of the image quality adjusting toner image is found by reading the value of the detection voltage Vp of the region indicated by C.

For the image quality adjusting toner image TP, a target density Pd is defined as a voltage value, for example, 0.2 V. During the image quality adjusting processing, it can be judged that the density is higher than the target density if the detection value of the light receiver 52b is smaller than 0.2 V, and the density is lower than the target density if the value is larger than 0.2 V. (Here, the value of the target density Pd is experimentally obtained with a value detected by the light receiver 52b when the image sensor 52 reads the image quality adjusting toner image TP, which is an image density confirmed by measurement in advance) Therefore, when the image density of the image quality adjusting toner image TP detected by the image sensor 52 is lower than the target density Pd, the image quality adjusting processor 24 adjusts the value of the developing bias DVb such that AD in FIG. 6 increases so that the image density of the image quality adjusting toner image satisfies the target density Pd. When the image density detected by the image sensor 52 of the image quality adjusting toner image TP is higher than the target density Pd, the value of the developing bias DVb is adjusted such that the value of AD in FIG. 6 becomes smaller, and the value of the developing bias DVb is decreased within a range not falling under the target density Pd.

By performing such image quality adjusting processing by the image quality adjusting processor 24 at the first interval (e.g., each time the value of the number n of processed sheets, which is the cumulative number of sheets on which an image is formed after the image quality adjusting processing is performed last time, reaches 300 sheets), which is a predetermined interval, the controller 20 can perform stable image formation without density fluctuation. The period during which the image quality adjusting processing is performed at the first interval is called the first period.

In this first period, the first processing of performing the image quality adjusting processing is performed each time a predetermined first interval elapses.

### First Cumulative Print Rate and Near-End Determination

As described above, the image quality adjusting processing by the image quality adjusting processor 24 is performed in order to perform stable image formation without density fluctuation. When the amount of toner remaining in the toner container 41 attached to the image forming device 10 decreases, the amount of toner supplied to the developing device 36 decreases or becomes unstable, and thus, there is a possibility that a light image is formed. Therefore, it is desirable to shorten the interval for performing the image quality adjusting processing when the toner in the toner container 41 is consumed and close to empty.

The controller 20 includes the near-end determining processor 25 and the first cumulative print rate calculator 27 in order to determine whether the toner container 41 is close to empty.

Based on a calculation result of the first cumulative print rate calculator 27, the near-end determining processor 25 determines whether the toner in the toner container 41 is consumed and close to empty. Here, near-end refers to a state where the toner amount in the toner container 41 has reached a predetermined remaining amount of toner. By setting near-end in this manner, it is possible to recognize that the toner amount in the toner container 41 is running low.

When the toner container detecting device 44 detects that the toner container 41 is attached to the body of the image forming device 10, the near-end determining processor 25 reads information on the toner amount housed in the toner container 41 from the storage of the terminal 41b.

The amount of toner stored in the storage of the terminal 41b of the toner container 41 according to the present embodiment is defined such that an image can be formed on 10,000 sheets if a value of the sheet print rate a, which is a ratio of an area occupied by the toner image with respect to a sheet area of a sheet of a predetermined size, for example, A4 size, is, for example, 5%. That is, the image forming processing can be performed on a larger number of sheets for an image of which the value of the sheet print rate a is smaller than 5%, but the image forming processing can only be performed on a smaller number of sheets in a case of an image of which the value of the sheet print rate a is larger than 5%. Therefore, the amount of toner remaining in the toner container 41 cannot be accurately predicted only by the information on the number of sheets subjected to the image forming processing.

Therefore, after the near-end determining processor 25 detects that a new toner container 41 is attached from the toner amount information read from the storage of the terminal 41b of the toner container 41, the first cumulative print rate calculator 27 calculates, from image data, the sheet print rate α, which is a ratio between the area of the toner image formed during the image forming processing and the area of the sheet on which the toner image is formed, and calculates a first cumulative print rate β1 obtained by adding and cumulating the sheet print rate a obtained each time the image forming processing is performed.

Then, at a time point when the value of the first cumulative print rate β1 reaches a first reference value U1, which is a predetermined value, in this case, 45,000%, the near-end determining processor 25 determines that the toner container 41 is close to empty (near-end).

Here, 45,000%, which is the value of the first reference value U1, is the first cumulative print rate β1 when an image of a sheet with sheet print rate of 5% is formed on 9,000 sheets. That is, in the toner container 41, the image forming processing can be performed on 10,000 sheets with a sheet with the sheet print rate of 5%, and therefore it is meant a state where 90% of the toner is consumed and 10% of the original toner remains. This first reference value is stored in the storage 22 in advance.

Since the first reference value is set in advance as described above, the near-end determining processor 25 can determine (can detect near-end) a near-end state where 10% of the toner remains in the toner container by confirming the value of the first cumulative print rate β1.

When the near-end determining processor 25 detects near-end as described above, the controller 20 changes the performing interval of the image quality adjusting processing so that the image quality adjusting processing is performed at the second interval (e.g., each time the number of sheets on which image formation has been performed reaches 50 sheets), which is shorter than the first interval. Such control can perform, even if the remaining amount of toner in the toner container 41 becomes small and density change is likely to occur, stable image formation without density fluctuation.

Note that the amount of toner housed in the toner container 41 is 150 g in mass. This is obtained by multiplying the toner amount (e.g., 0.015 g) consumed per sheet having a sheet print rate of 5%, which is obtained in advance by an experiment, by 100,000, but it is difficult to measure the mass of the toner actually consumed. Therefore, use of the first cumulative print rate β1 described above enables the remaining amount of toner in the toner container 41 to be easily predicted.

As described above, by performing the image quality adjusting processing at the second interval shorter than the first interval in the second period, which is a period after the near-end determining processor 25 detects near-end, it is possible to prevent the density of the toner image from decreasing even when the remaining amount of toner in the toner container 41 decreases, but when the toner in the toner container 41 runs out and is empty during the image forming processing, the toner amount in the developing tank 40 may be insufficient and the image density may decrease.

In order to prevent this, in the known technique mentioned earlier, the developing device 36 is provided with a toner density sensor that detects the toner amount in the developing tank 40, and when the toner amount detected by the toner density sensor does not reach a predetermined toner amount even if the toner refill device 43 is driven, it is supposed to stop the image forming processing due to the toner container 41 becoming empty (toner end).

However, as mentioned earlier, it is necessary to provide the toner density sensor, and there is a problem of a cost increase.

Therefore, the controller 20 of the present embodiment includes the remaining amount determining processor 26.

### Remaining Amount Determining Processing

The remaining amount determining processor 26 performs remaining amount determining processing of determining whether the toner in the toner container 41 is empty at a timing when the image quality adjusting processing is performed in the second period, which is a period after the near-end determining processor 25 detects near-end.

Here, the remaining amount determining processor 26 determines that the toner container 41 is empty (toner end) when the image density of the image quality adjusting toner image does not reach the target density Pd even if the developing bias DVb is adjusted during the image quality adjusting processing (even if the potential difference of AD in FIG. 6 is adjusted to be large). More specifically, when the image density of the image quality adjusting toner image does not reach the target density Pd during the image quality adjusting processing, the toner refill device 43 is forcibly driven for a predetermined time. That is, the image quality adjusting processing is performed again after the toner refill device 43 is driven for the predetermined time to forcibly perform the toner refill operation from the toner container 41 to the developing device 36. Then, it is determined that the toner container 41 is empty when the image density of the image quality adjusting toner image does not reach the target density Pd even if the toner refill device 43 is forcibly driven.

The remaining amount determining processor 26 performs the remaining amount determining processing as described above each time the image quality adjusting processing is performed in the second period. This can determine whether the toner container 41 is empty without providing a toner density sensor that detects the toner amount in the developing tank 40.

### Second Cumulative Print Rate Calculator

By performing also the remaining amount determining processing during the image quality adjusting processing in the second period as described above, it is possible to effectively perform prevention of a density decrease of the image and end detection of the toner container 41, but the controller 20 in the present embodiment further includes the second cumulative print rate calculator 28. Then, it is determined whether to perform the second processing of performing the image quality adjusting processing and the remaining amount determining processing based on a calculation result of the second cumulative print rate calculator 28.

By providing the second cumulative print rate calculator 28 in this manner, it is possible to perform the remaining amount determining processing at a more appropriate timing in the second period.

The second cumulative print rate calculator 28 calculates, from the image data, the sheet print rate a, which is the ratio between the area of the toner image on which an image is formed after the image quality adjusting processing is performed in the second period and the area of the sheet on which the toner image is formed, and calculates a second cumulative print rate β2 obtained by adding and cumulating the sheet print rates a obtained each time the image forming processing is performed.

The storage 22 stores a second reference value U2, which is a value smaller than the first reference value U1.

Here, the second reference value U2 is, for example, 125%, which is smaller than 45,000%, which is the first reference value U1.

By doing this, in the second period, in a case where a toner image with a sheet print rate of 5%, for example, is continuously formed, the remaining amount determining processing is performed at a time point when an image is formed on 25 sheets (the value of the second cumulative print rate β2 is 125%), and in a case where a toner image with a sheet print rate of 50% as an another example is continuously formed, the remaining amount determining processing is performed at a time point when an image is formed on 3 sheets (the value of the second cumulative print rate β2 is 150%), and therefore the remaining amount determining processing can be performed at an appropriate timing in accordance with the actual consumption amount of toner.

### Continuation Determiner

The controller 20 of the present embodiment further includes the continuation determiner 29. During the image forming processing in the second period (or the first period), the continuation determiner 29 determines whether a state is a first state K1 where next image data that is image data to perform the next image forming processing is present (received by the image forming processor 23), or to be a second state K2 where the next image data is not present (not received by the image forming processor 23). Then, the controller 20 determines whether to perform the second processing including the remaining amount determining processing and the image quality adjusting processing based on the results of the second cumulative print rate calculator 28 and the continuation determiner 29 in the second period. Specifically, when the determination result of the continuation determiner 29 at the time point when the value of the second cumulative print rate β2 reaches the second reference value U2 is the second state K2, that is, a state where the image data to perform the next image forming processing is not present, the controller 20 performs the second processing including the remaining amount determining processing. and the image quality adjusting processing.

Doing this enables the image forming processing and the remaining amount determining processing to be performed at the time point (second state K2) when the image forming processing ends, and occurrence of a waiting time to wait for end of these processing to be suppressed. (There is no waiting time because the processing is performed after the image forming processing ends)

Furthermore, the controller 20 of the present embodiment stores a third reference value U3, which is larger than the value of the second reference value U2 and smaller than the first reference value U1, in the storage 22. Here, the third reference value U3 is, for example, 250%.

Here, even if the value of the second cumulative print rate β2 exceeds the second reference value during the image forming processing in the second period, when next image data, which is image data for the continuation determiner 29 to perform the next image forming processing is present (in a case of the first state K1), the controller 20 continues the image forming processing. Then, at a time point when the continuation determiner 29 determines the second state K2 or the second cumulative print rate β2 reaches the third reference value, the second processing including the image quality adjusting processing and the remaining amount determining processing is performed.

By performing such control, it is possible to accurately detect toner end while reducing the frequency of interrupting the image forming processing in the second period.

### Display

When the remaining amount determining processor 26 detects toner end, the image forming device 10 of the present embodiment stops the image forming processing or stops reception of image data, and displays, on the display 73, a message indicating that the toner container 41 is empty to notify the operator that it is necessary to replace the toner container 41.

This configuration can perform notification of toner end and suggestion of replacement of the toner container 41.

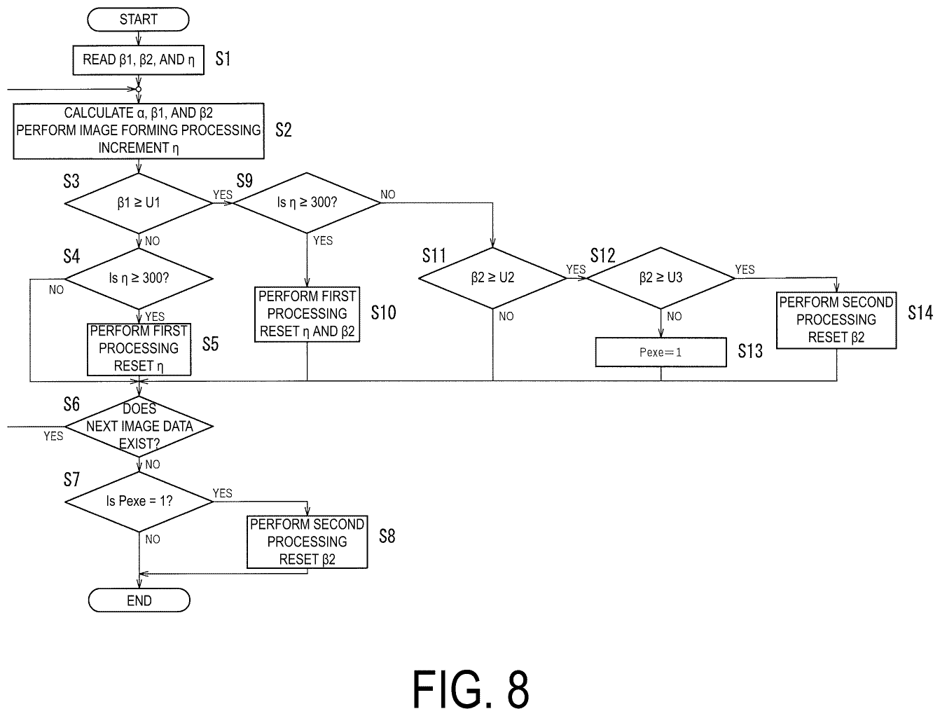

Here, image forming processing, image quality adjusting processing, and remaining amount determining processing performed at the processor 21 by the controller 20 of the present embodiment will be described with reference to FIG. 8.

FIG. 8 is a flowchart showing various operations performed at the processor 21 by the controller 20.

When executing the image forming processing, the controller 20 performs, in step S1, processing of reading, from the storage 22, the first cumulative print rate β1, the second cumulative print rate β2, and the number η of processed sheets, which is the cumulative number of sheets on which an image is formed after the image quality adjusting processing is performed last time. Then, the processing proceeds to the next step S2.

In step S2, the controller 20 calculates the sheet print rate α based on the image data, and controls the image forming device 10 to form an image on the sheet P. Then, the sheet print rate a is added to each of the first cumulative print rate β1 and the second cumulative print rate β2, and is stored again in the storage 22. The number η of processed sheets is incremented and stored in the storage 22. Then, the processing proceeds to the next step S3.

In step S3, the controller 20 determines whether the first cumulative print rate β1 is the first reference value U1 stored in the storage 22 or more. Here, if the value of the first cumulative print rate β1 is the first reference value U1 or more, the processing proceeds to step S9. On the other hand, if the value of the first cumulative print rate β1 is not the first reference value U1 or more, the processing proceeds to step S4.

In step S4, the controller 20 confirms the value of the number n of processed sheets, and if the value of the number η of processed sheets is 300 or more, the processing proceeds to step S5. On the other hand, if the value of the number n of processed sheets is not 300 or more, the processing proceeds to step S6.

In step S5, after performing the image quality adjusting processing, the controller 20 resets the value of the number n of processed sheets and proceeds with the processing to step S6.

In step S6, the controller 20 determines, by the continuation determiner 29, whether next image data that is image data to be formed next is present. If the next image data is present, the processing proceeds to step S2, and the next image forming processing is performed. On the other hand, if the next image data is not present, the processing proceeds to step S7.

In step S7, the controller 20 confirms a value stored in a flag variable Pexe. Then, if the value of the flag variable Pexe is 1, the processing proceeds to step S8. On the other hand, if the value of the flag variable Pexe is not 1, the image forming processing is completed.

In step S8, the controller 20 performs the image quality adjusting processing and the remaining amount determining processing, resets the value of the second cumulative print rate β2, and then completes the image forming processing.

If the first cumulative print rate β1 is smaller than the first reference value U1 as described above, the first processing (image quality adjusting processing) is performed at the timing when the number n of processed sheets becomes 300 or more. This can form an image with a stable image density constantly.

Next, processing when the value of the first cumulative print rate 1 is the first reference value U1 or more will be described.

In step S3, if the first cumulative print rate β1 is the first reference value U1 or more, the value of the number n of processed sheets is confirmed in step S9. If the value of the number n of processed sheets is 300 or more, the processing proceeds to step S11. On the other hand, if the value of the number n of processed sheets is not 300 or more, the processing proceeds to step S10.

In step S4, the controller 20 confirms the value of the number n of processed sheets, and if the value of the number n of processed sheets is 300 or more, the processing proceeds to step S10. On the other hand, if the value of the number n of processed sheets is not 300 or more, the processing proceeds to step S11.

In step S10, the controller 20 performs the first processing (final), resets the number n of processed sheets, and proceeds with the processing to step S6.

In step S11, the controller 20 confirms the value of the second cumulative print rate β2. If the value of the second cumulative print rate β2 is the second reference value U2 (e.g., 125%) or more, the processing proceeds to step S12. On the other hand, if the value of the second cumulative print rate β2 is not the second reference value U2 or more, the processing proceeds to step S6.

In step S12, the controller 20 confirms the value of the second cumulative print rate β2. If the value of the second cumulative print rate β2 is the third reference value U3 (e.g., 250%) or more, the processing proceeds to step S14. On the other hand, if the value of the second cumulative print rate β2 is not the third reference value U3 or more, the processing proceeds to step S13.

In step S13, the controller 20 changes the value of the flag variable Pexe to 1 (the default value is 0), and proceeds with the processing to step S6.

In step S14, after performing the second processing (image quality adjusting processing and remaining amount determining processing), the controller 20 resets the second cumulative print rate β2 and proceeds with the processing to step S6.

If the first cumulative print rate β1 is larger than the first reference value U1 as described above, the second processing (image quality adjusting processing and remaining amount determining processing) is performed based on the value of the second cumulative print rate β2 and the determination result of the continuation determiner 29. This enables the image quality adjusting processing and the remaining amount determining processing to be performed at shorter intervals than in the case where the first cumulative print rate β1 is smaller than the first reference value U1, and therefore it is possible to form an image with a stable image density constantly even if the remaining amount of toner decreases and the image density easily decreases. Since the remaining amount determination as to whether the toner has run out is also performed at the timing when a predetermined toner amount has been consumed, accurate determination can be performed.

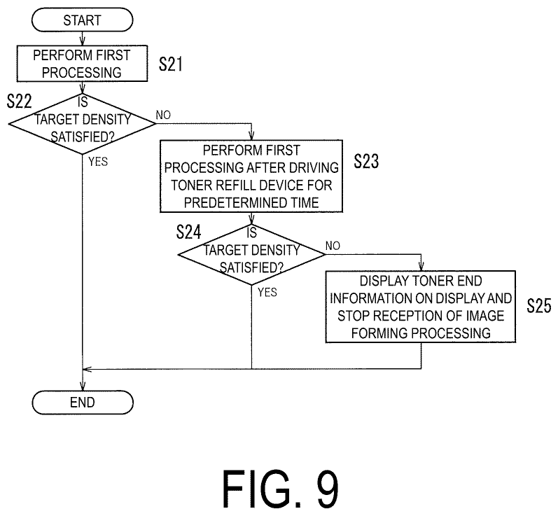

The remaining amount determining processing performed at the processor 21 by the controller 20 will be described with reference to FIG. 9.

As mentioned earlier, the controller 20 performs the image quality adjusting processing and the remaining amount determining processing at the time of performing the second processing.

FIG. 9 is a flowchart showing an operation performed by the controller 90 during the second processing.

The controller 20 performs the image quality adjusting processing in step S21. That is, the image quality adjusting toner image TP is formed, the image density of the image quality adjusting toner image TP that is formed is read by the image sensor 52, and the processing proceeds to the next step S22.

In step S22, the controller 20 ends the processing if the detection value of the image sensor 52 of the image quality adjusting toner image TP satisfies the target density, and proceeds with the processing to step S23 if the detection value does not satisfy the target density.

In step S23, the controller 20 drives the toner refill device 43 for a predetermined time to perform a refill operation of refilling toner to the developing device 36. Then, the image quality adjusting processing is executed again, the image sensor 52 reads the image quality adjusting toner image TP, and the processing proceeds to step S24.

In step S24, the controller 20 ends the processing if the detection value of the image sensor 52 of the image quality adjusting toner image TP satisfies the target density, and proceeds with the processing to step S25 if the detection value does not satisfy the target density.

In step S25, the controller 20 displays, on the display 73, a state where there is no toner in the toner container 41, that is, a toner end state, and thereafter, brings a reception stop state where reception of the image forming processing is stopped, and stops the processing.

The controller 20 can perform the remaining amount determining processing by performing the above operation.

That is, it is possible to appropriately determine whether toner remains in the toner container 41 even without providing the developing device 36 with a toner density sensor that detects the amount of toner.

### Color Multifunction Peripheral

While the image forming device according to the disclosure has been described with a monochrome multifunction peripheral as an example, the image forming device may be applied to a color multifunction peripheral that forms multi-color images (color images).

The color multifunction peripheral is different from the monochrome multifunction peripheral in that an image former includes a plurality of photoconductive drums and an intermediate transferring device.

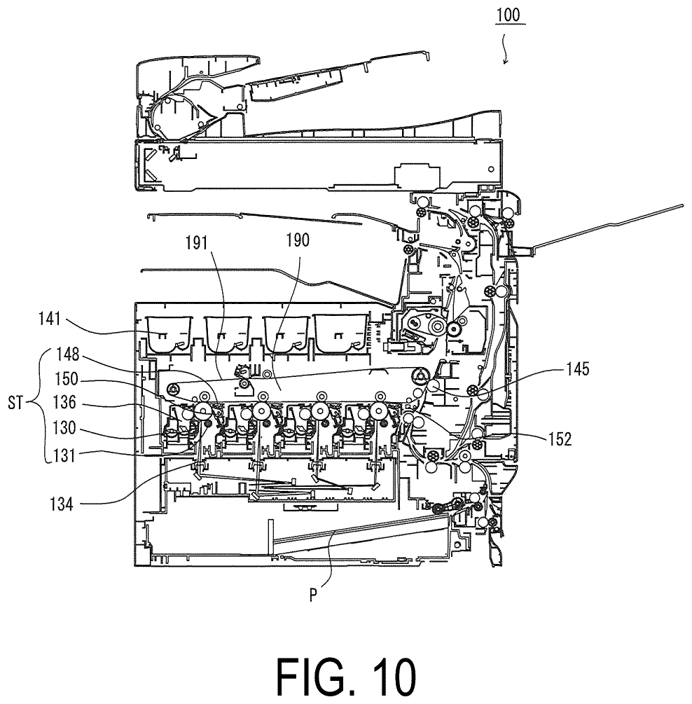

FIG. 10 is a cross-sectional view illustrating a schematic configuration of a color image forming device 100 according to an embodiment of the disclosure.

The color image forming device 100 includes a plurality of image stations ST including a photoconductive drum 130, a charging device 131, a developing device 136, a static eliminating device 148, and a cleaning device 150 in order to form a toner image for each color. (Although not illustrated, a corresponding developing power supply is connected to each developing device 136) The color image forming device 100 includes an exposing device 134 that exposes each photoconductive drum 130, a toner container 141 to refill toner to the developing device 136 of each color, a toner refill device corresponding to each toner container 141 (not illustrated), and an intermediate transferring device 190 including an intermediate transfer medium 191 (image carrier) to which a toner image formed on each photoconductive drum 130 is intermediately transferred. In the color image forming device 100, an image sensor 152 detects the image density of the toner image intermediately transferred to the intermediate transfer medium 191, and a transferring device 145 transfers, to the sheet P, the toner image intermediately transferred to the intermediate transfer medium 191.

In such a configuration, the toner image formed at each image station ST is transferred to the intermediate transfer medium 191, and the image density of the toner image transferred to the intermediate transfer medium 191 is detected by the image sensor 152, whereby control similar to that of the image forming device 10 (monochrome image forming device) can be performed.

That is, by providing the image sensor 152 toward the intermediate transfer medium 191, the image density of the toner image formed at each developing device 136 can be measured by one sensor, and eventually, the remaining amount determining processing of determining the remaining amount of toner in each toner container 141 can be performed.

A configuration disclosed in any embodiment described above can be applied in combination with a configuration disclosed in another embodiment as long as no contradiction arises. The embodiments disclosed in the present description are merely examples, and the embodiment of the disclosure is not limited to this and can be appropriately modified within a range not departing from the object of the disclosure.

### REFERENCE SIGNS LIST

10 Image forming device
20 Controller
22 Storage
23 Image forming processor
24 Image quality adjusting processor
25 Remaining amount determining processor
26 First cumulative print rate calculator
27 Second cumulative print rate calculator
28 Continuation determiner
30 Photoconductive drum (image carrier)
36 Developing device
37 Developing power supply
41 Toner container
43 Toner refill device
44 Toner container detector
52 Image sensor
72 Display
V0 Surface potential of non-image region of photoconductive drum
VL Surface potential of image region of photoconductive drum
DVb Developing bias
α Sheet print rate
β1 First cumulative print rate
β2 Second cumulative print rate
U1 First reference value
U2 Second reference value
U3 Third reference value

1. An image forming device that forms an image on a sheet, the image forming device comprising:
a toner container housing a toner inside;
a developing mechanism that forms a toner image on a surface of an image carrier using the toner supplied from the toner container;
a developing power supply that supplies the developing mechanism with a developing bias, which is a predetermined voltage;
an image sensor that detects an image density of the toner image; and
a controller that can execute image forming processing of forming the toner image on the surface of the image carrier based on image data that is electronic data of the image formed on the sheet and image quality adjusting processing of forming an image quality adjusting toner image, which is a predetermined toner image, on the surface of the image carrier and adjusting a value of the developing bias based on image density information detected by the image sensor,
wherein the controller
includes a first cumulative print rate calculator that calculates a first cumulative print rate obtained by adding and cumulating a sheet print rate, which is a ratio between an area of the toner image formed during the image forming processing and an area of the sheet, is calculated from the image data and the sheet print rate obtained each time the image forming processing is performed and
a remaining amount determining processor that determines whether the toner remains in the toner container based on image density information of the image quality adjusting toner image detected by the image sensor when the image quality adjusting processing is performed,
executes, at a first interval, which is a predetermined interval, first processing of performing only the image quality adjusting processing in a first period, which is a period until the first cumulative print rate exceeds a predetermined first reference value and the first image quality adjusting processing is performed, and
performs the image quality adjusting processing at a second interval shorter than the first interval and executes second processing of performing determining processing by using the remaining amount determining processor in a second period, which is a period after a time point at which the image quality adjusting processing is executed first time after the first cumulative print rate exceeds the first reference value.

2. The image forming device according to claim 1, wherein
the controller
further includes a second cumulative print rate calculator that calculates a second cumulative print rate obtained by adding and cumulating the sheet print rate of the image newly formed in the image forming processing after the image quality adjusting processing is performed in the second period each time the image forming processing is performed,
the first interval is defined by the number of processed sheets, which is the number of sheets to be subjected to the image forming processing, and
the second interval is defined by a value of the second cumulative print rate.

3. The image forming device according to claim 1, wherein
the controller
further includes a second cumulative print rate calculator that calculates a second cumulative print rate obtained by adding and cumulating the sheet print rate of the image newly formed in the image forming processing after the image quality adjusting processing is performed in the second period each time the image forming processing is performed and
a continuation determiner that determines whether a state is a first state where next image data that is the image data to perform next image forming processing is present or a second state where the next image data is not present during the image forming processing in the second period and
determines whether to perform the second processing based on results of the second cumulative print rate calculator and the continuation determiner in the second period.

4. The image forming device according to claim 3, wherein
the controller
executes the second processing if a value of the second cumulative print rate has reached a second reference value, which is a value smaller than the first reference value, in a case where the continuation determiner determines that a state is the second state during the image forming processing in the second period, and
performs the second processing if the value of the second cumulative print rate has reached a third reference value, which is larger than the second reference value and smaller than the first reference value, in a case where the continuation determiner determines the first state during the image forming processing.

5. The image forming device according to claim 4, wherein the third reference value is equal to or less than twice the second reference value.

6. The image forming device according to claim 1, wherein the remaining amount determining processor determines that the toner is not in the toner container in a case where the image density detected by the image sensor of the image quality adjusting toner image that is formed does not reach a target density even by changing the value of the developing bias and forming the image quality adjusting toner image during the image quality adjusting processing.

7. The image forming device according to claim 6, wherein
the image forming device further includes a display, and
the controller displays, on the display, a message indicating that the toner container is empty in a case where the remaining amount determining processor determines that the toner does not remain in the toner container.
